(19) United States
(12) Patent Application Publication
(10) Pub. No.: US 2019/0030894 A1
(43) Pub. Date: Jan. 31, 2019

(54) METHOD FOR PRODUCING NOZZLE PLATE AND METHOD FOR PRODUCING LIQUID JET HEAD

(71) Applicant: SII Printek Inc., Chiba-shi (JP)

(72) Inventor: Atsushi KOZUKI, Chiba-shi (JP)

(21) Appl. No.: 16/043,493

(22) Filed: Jul. 24, 2018

(30) Foreign Application Priority Data
Jul. 25, 2017 (JP) 2017-143661

(51) Int. Cl. B41J 2/16

(52) U.S. Cl. CPC B41J 2/1634; B41J 2202/22; B41J 2/162

(57) ABSTRACT

An object of the present invention is to provide a method for producing a nozzle plate and a method for producing a liquid jet head, each capable of improving the discharge accuracy of a nozzle. A method for producing a nozzle plate according to an embodiment includes a substrate preparation step of preparing a coating agent-applied substrate in which a coating agent is applied to at least a part of a nozzle plate substrate, a nozzle hole formation step of forming a nozzle hole in a region, to which the coating agent is applied, of the coating agent-applied substrate after the substrate preparation step, and a coating agent removal step of removing the coating agent after the nozzle hole formation step.

### RELATED APPLICATIONS

This application claims priority under 35 U.S.C. § 119 to Japanese Patent Application No. 2017-143661 filed on Jul. 25, 2017, the entire content of which is hereby incorporated by reference.

### BACKGROUND OF THE INVENTION

### Field of the Invention

The present invention relates to a method for producing a nozzle plate and a method for producing a liquid jet head.

### Background Art

Conventionally, there is an ink jet printer (liquid jet device) including an ink jet head (liquid jet head) as a device which discharges an ink in the form of a droplet onto a recording medium such as a recording paper to record an image or a character on the recording medium. The ink jet head includes a nozzle plate in which a nozzle that discharges an ink is formed.

For example, JP-A-2014-65220 discloses a method for producing a nozzle plate, in which a part of a metal layer in a stacked body of a resin layer and a metal layer is removed, thereby exposing the resin layer, and thereafter a nozzle is formed so as to open in a region exposed from the metal layer in the resin layer.

However, a residue sometimes occurred during the formation of the nozzle. In particular, when a residue occurring during the formation of the nozzle remained around the nozzle hole, there was a possibility that the discharged ink deflected, and therefore, the discharge accuracy of the nozzle was deteriorated.

### SUMMARY OF THE INVENTION

The invention has been made for solving the above problem, and an object thereof is to provide a method for producing a nozzle plate and a method for producing a liquid jet head, each capable of improving the discharge accuracy of a nozzle.

A method for producing a nozzle plate according to one embodiment of the invention includes a substrate preparation step of preparing a coating agent-applied substrate in which a coating agent is applied to at least a part of a nozzle plate substrate, a nozzle hole formation step of forming a nozzle hole in a region, to which the coating agent is applied, of the coating agent-coated substrate after the substrate preparation step, and a coating agent removal step of removing the coating agent after the nozzle hole formation step.

According to this method, even if a residue (hereinafter also referred to as “debris”) occurs during the formation of a nozzle hole, the debris can be collectively removed together with the coating agent in the coating agent removal step, and therefore, the removal of the debris can be easily performed. Accordingly, the discharge accuracy of the nozzle can be improved.

In the method for producing a nozzle plate, the substrate preparation step may include a joined body preparation step of preparing a joined body of the nozzle plate substrate and a cover plate having an opening portion for exposing a nozzle hole forming region of the nozzle plate substrate, and a coating agent application step of applying the coating agent to at least the nozzle hole forming region of the joined body after the joined body preparation step.

In the meantime, as a method for removing a debris, there is a method using an adhesive tape without using a coating agent. However, in the case where a debris occurs in the nozzle hole forming region, the opening portion of the cover plate is generally smaller than a fingertip, and therefore, the adhesive tape does not sufficiently penetrate into the nozzle hole forming region, and there is a possibility that the debris cannot be sufficiently removed. On the other hand, according to this method, even in the case where a debris occurs in the nozzle hole forming region, the debris can be collectively removed together with the coating agent in the coating agent removal step, and therefore, this method is preferred.

In the method for producing a nozzle plate, in the coating agent application step, the coating agent may be applied to the nozzle hole forming region and an inner surface surrounding the opening portion of the cover plate.

According to this method, even in the case where a debris occurs on the inner surface surrounding the opening portion of the cover plate in addition to the nozzle hole forming region, the debris in each place can be collectively removed together with the coating agent in the coating agent removal step. Therefore, the appearance of the nozzle plate can be improved.

In the method for producing a nozzle plate, in the coating agent application step, the coating agent may be applied to the nozzle hole forming region and an outer surface on the opposite side to a joining surface to the nozzle plate substrate of the cover plate.

According to this method, even in the case where a debris occurs on the outer surface of the cover plate in addition to the nozzle hole forming region, the debris in each place can be collectively removed together with the coating agent in the coating agent removal step. Therefore, the appearance of the nozzle plate can be improved.

In the method for producing a nozzle plate, in the nozzle hole formation step, the nozzle hole may be formed using a laser beam.

According to this method, a debris is more likely to occur as compared with the case where the nozzle hole is formed using a punch, and therefore, the practical benefit for removing the debris is high.

In the method for producing a nozzle plate, in the coating agent removal step, the coating agent may be removed by washing with water.

According to this method, the removal of the debris can be performed more easily at lower cost as compared with the case where the coating agent is removed using a chemical solution.

A method for producing a liquid jet head according to one embodiment of the invention includes producing a nozzle plate using the method for producing a nozzle plate.

According to this method, in the method for producing a liquid jet head including producing a nozzle plate using the method for producing a nozzle plate, the discharge accuracy of the liquid jet head can be improved.

According to the invention, a method for producing a nozzle plate and a method for producing a liquid jet head, each capable of improving the discharge accuracy of a nozzle can be provided.

### BRIEF DESCRIPTION OF THE DRAWINGS

FIG. 1 is a perspective view of an ink jet printer of an embodiment.

FIG. 2 is a perspective view of an ink jet head of the embodiment.

FIG. 3 is a perspective view of a head chip of the embodiment.

FIG. 4 is an exploded perspective view of the head chip of the embodiment.

FIGS. 5A to 5D are process diagrams for illustrating a method for producing a nozzle plate of the embodiment. FIG. 5A is a process diagram for illustrating a joined body preparation step of the embodiment. FIG. 5B is a process diagram for illustrating a coating agent application step of the embodiment. FIG. 5C is a process diagram for illustrating a nozzle hole formation step of the embodiment. FIG. 5D is a process diagram for illustrating a coating agent removal step of the embodiment.

### DETAILED DESCRIPTION OF THE PREFERRED EMBODIMENTS

Hereinafter, embodiments according to the invention will be described with reference to the drawings. In the following embodiments, an ink jet printer (hereinafter also simply referred to as “printer”) which performs recording on a recording medium using an ink (liquid) will be described as an example. In the drawings used in the following description, the scales of the respective members are appropriately changed so that the respective members have recognizable sizes.

### Printer

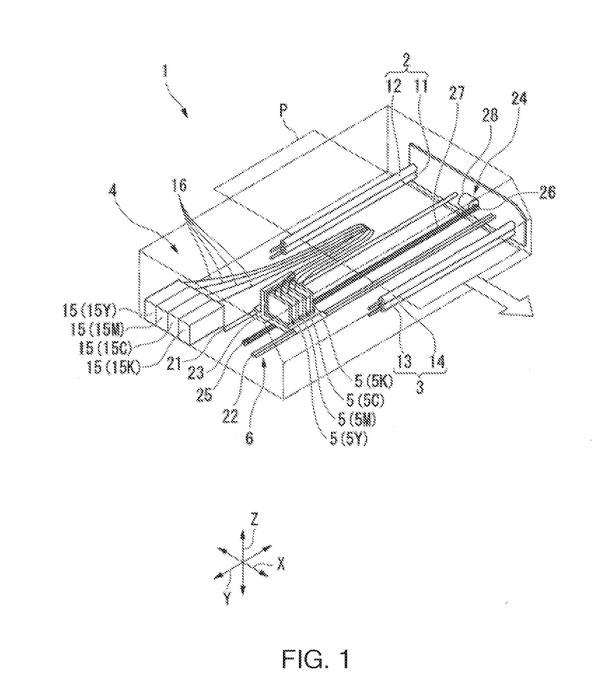

FIG. 1 is a perspective view of an ink jet printer of an embodiment.

As shown in FIG. 1, a printer 1 of the embodiment includes a pair of conveyance mechanisms 2 and 3, an ink supply mechanism 4, ink jet heads 5 (liquid jet heads), and a scanning mechanism 6. In the following description, an explanation will be given using an XYZ orthogonal coordinate system as needed. The X direction is a conveyance direction of a recording medium P (for example, a paper or the like). The Y direction is a scanning direction of the scanning mechanism 6. The Z direction is a height direction (vertical direction) orthogonal to the X direction and the Y direction.

The conveyance mechanisms 2 and 3 convey the recording medium P in the X direction. Specifically, the conveyance mechanism 2 includes a grid roller 11 extending in the Y direction, a pinch roller 12 extending parallel to the grid roller 11, and a drive mechanism (not shown) such as a motor for axially rotating the grid roller 11. The conveyance mechanism 3 includes a grid roller 13 extending in the Y direction, a pinch roller 14 extending parallel to the grid roller 13, and a drive mechanism (not shown) for axially rotating the grid roller 13.

The ink supply mechanism 4 includes ink tanks 15, each of which stores an ink, and ink tubes 16, each of which connects each ink tank 15 to each ink jet head 5.

The ink tanks 15 are, for example, ink tanks 15Y, 15M, 15C, and 15K, which store inks of four colors: yellow, magenta, cyan, and black, respectively. In this embodiment, the ink tanks 15Y, 15M, 15C, and 15K are arranged side by side in the X direction.

For example, the ink tubes 16 are flexible hoses having flexibility. The ink tubes 16 connect the respective ink tanks 15 to the respective ink jet heads 5 separately.

The scanning mechanism 6 allows the ink jet heads 5 to scan back and forth in the Y direction. Specifically, the scanning mechanism 6 includes a pair of guide rails 21 and 22 extending in the Y direction, a carriage 23 movably supported by the pair of guide rails 21 and 22, and a drive mechanism 24 for moving the carriage 23 in the Y direction.

The drive mechanism 24 is disposed between the guide rails 21 and 22 in the X direction. The drive mechanism 24 includes a pair of pulleys 25 and 26 which are disposed spaced apart in the Y direction, an endless belt 27 which is wound between the pair of pulleys 25 and 26, and a drive motor 28 which rotatably drives the pulley 25.

The carriage 23 is connected to the endless belt 27. On the carriage 23, the ink jet heads 5 are mounted in a state of being arranged side by side in the Y direction. In this embodiment, the ink jet heads 5 are ink jet heads 5Y, 5M, 5C, and 5K capable of discharging the inks of four colors: yellow, magenta, cyan, and black, respectively.

### Ink Jet Head

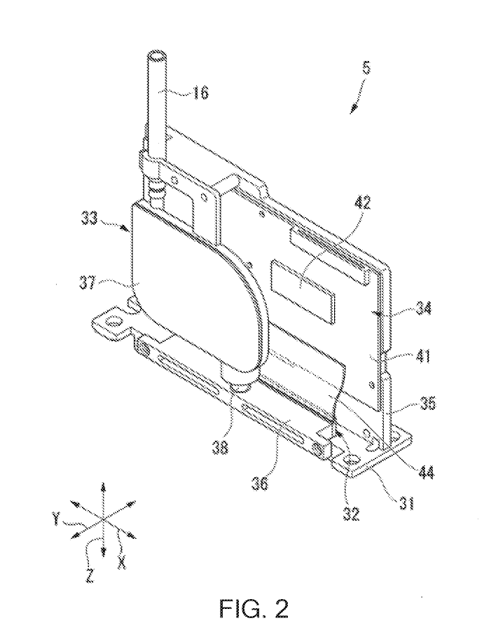

FIG. 2 is a perspective view of the ink jet head of the embodiment. The ink jet heads 5Y, 5M, 5C, and 5K all have the same configuration except for the color of the ink to be supplied, and therefore will be collectively described as the ink jet head 5 in the following description.

As shown in FIG. 2, the ink jet head 5 includes a fixing plate 31 which is fixed to the carriage 23 (see FIG. 1), a head chip 32 which is fixed on the fixing plate 31, an ink supply portion 33 which supplies the ink supplied from the ink supply mechanism 4 (see FIG. 1) to the head chip 32, and a control portion 34 which applies a drive voltage to the head chip 32.

To the fixing plate 31, a base plate 35 is fixed in a standing state in the Z direction.

The ink supply portion 33 includes a flow path member 36 which is fixed to the fixing plate 31, a pressure damper 37 which is fixed to the base plate 35, and an ink connection tube 38 which connects the flow path member 36 to the pressure damper 37.

To the pressure damper 37, the ink tube 16 is connected. When the pressure damper 37 is supplied with the ink through the ink tube 16, the ink is once stored therein. The pressure damper 37 supplies the stored ink to the head chip 32 through the ink connection tube 38 and the flow path member 36.

The control portion 34 includes an IC substrate 41 which is fixed to the base plate 35 and a control circuit 42 which is mounted on the IC substrate 41.

The control circuit 42 includes an integrated circuit for driving the head chip 32, and the like. The control circuit 42 is electrically connected to the head chip 32 through a flexible printed wiring board 44 having a wiring pattern (not shown) printed thereon.

### Head Chip

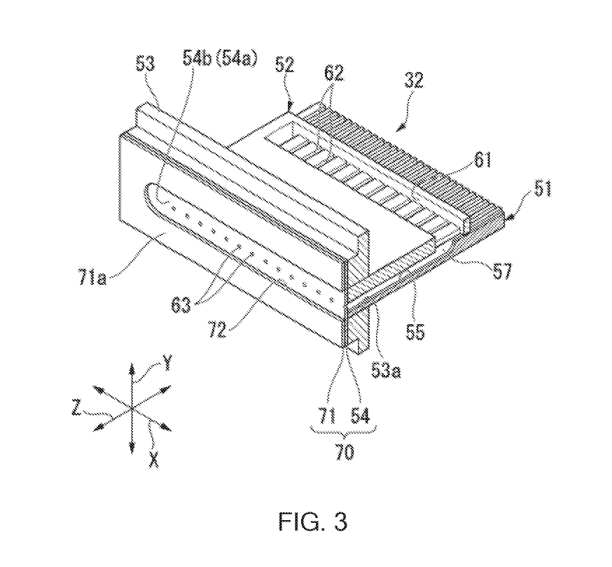

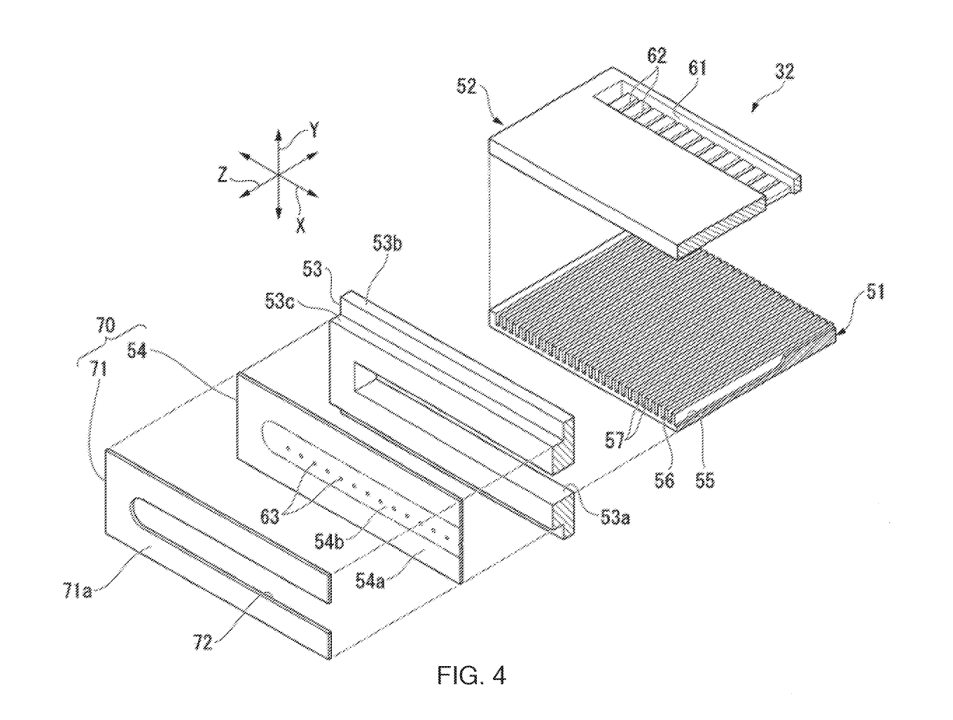

FIG. 3 is a perspective view of the head chip of the embodiment. FIG. 4 is an exploded perspective view of the head chip of the embodiment.

The head chip 32 shown in FIGS. 3 and 4 is of a so-called edge shoot type in which the ink is discharged from an edge portion in the extending direction (Z direction) of a discharge channel 55. Specifically, as shown in FIG. 3, the head chip 32 includes an actuator plate 51, a cover plate 52, a support plate 53, and a nozzle plate body 70. In the following description, the cover plate 52 side in the Y direction is referred to as “front side”, and the actuator plate 51 side in the Y direction is referred to as “back side”. Further, the nozzle plate body 70 side in the Z direction is referred to as “lower side”, and a side opposite to the nozzle plate body 70 side in the Z direction is referred to as “upper side”.

The actuator plate 51 is a so-called monopole substrate whose polarization direction is set to one direction along the thickness direction (Y direction). For example, as the actuator plate 51, a ceramic substrate composed of lead zirconate titanate (PZT) or the like is preferably used. The actuator plate 51 may be of a so-called chevron type formed by stacking two piezoelectric substrates whose polarization directions differ from each other in the Z direction.

As shown in FIG. 4, on the surface of the actuator plate 51, a plurality of channels 55 and 56 are arranged side by side at intervals in the X direction. Each of the channels 55 and 56 is formed in a linear shape along the Z direction. Therefore, each of the channels 55 and 56 is partitioned in the X direction by a drive wall 57 composed of the actuator plate 51.

The plurality of channels 55 and 56 include a discharge channel 55 which is filled with an ink and a non-discharge channel 56 which is not filled with an ink. The discharge channel 55 and the non-discharge channel 56 are alternately arranged side by side in the X direction. On the drive wall 57, a drive electrode (not shown) is formed by vapor deposition or the like. The drive electrode deforms the drive wall 57 due to a piezoelectric slip effect by applying a drive voltage thereto through the flexible printed wiring board 44 (see FIG. 2).

The cover plate 52 is formed in a rectangular shape in a plan view seen from the Y direction. As shown in FIG. 3, the cover plate 52 is joined to the surface of the actuator plate 51 in a state where an upper end portion of the actuator plate 51 is exposed.

On the front surface of the cover plate 52, a common ink chamber 61 is formed. On the back surface of the cover plate 52, a plurality of slits 62 are formed.

The common ink chamber 61 is formed at a position equivalent to that of the upper end portion of the discharge channel 55 in the Z direction. The common ink chamber 61 is recessed toward the back surface side of the cover plate 52 and also extends in the X direction. The ink flows in the common ink chamber 61 through the flow path member 36 (see FIG. 2).

The slits 62 are formed in the common ink chamber 61 at positions facing the discharge channels 55 in the Y direction. Each of the slits 62 allows the inside of the common ink chamber 61 and the inside of each of the discharge channels 55 to communicate with each other separately. On the other hand, the non-discharge channels 56 do not communicate with the inside of the common ink chamber 61

The support plate 53 supports the actuator plate 51 and the cover plate 52, and also supports the nozzle plate body 70 simultaneously. The support plate 53 is a rectangular frame-shaped plate material formed long in the X direction so as to correspond to the actuator plate 51. As shown in FIG. 4, in the support plate 53, a fitting hole 53a which penetrates the plate in the Z direction and extends along the X direction is formed. As shown in FIG. 3, the actuator plate 51 and the cover plate 52 are supported by the support plate 53 in a state of being fitted in the fitting hole 53a.

The support plate 53 is formed in a stepped plate shape so that the plate becomes smaller toward the lower side due to a step difference. That is, the support plate 53 is configured such that a base portion 53b which is located on the upper side and a step portion 53c which is disposed on the lower surface of the base portion 53b and is formed so that the outer shape thereof is smaller than that of the base portion 53b are integrally formed. The support plate 53 is combined so that the lower surface of the step portion 53c and the lower surface of the actuator plate 51 are flush with each other. For example, to the lower surface of the step portion 53c, the nozzle plate body 70 is fixed by bonding or the like.

### Nozzle Plate Body

As shown in FIG. 4, the nozzle plate body 70 includes a nozzle plate 54 which is in contact with the lower surface of the actuator plate 51 and a nozzle cover plate 71 provided on a lower surface 54a (a surface on the opposite side to the actuator plate 51) of the nozzle plate 54. Hereinafter, the lower surface 54a of the nozzle plate 54 is also referred to as “discharge surface 54a”.

### Nozzle Plate

For example, the nozzle plate 54 is made of a resin material such as polyimide. The material of the nozzle plate 54 is not limited to a resin material, and the nozzle plate 54 may be made of a metal material such as stainless steel (SUS), silicon, glass or the like. Further, the nozzle plate 54 may be configured to have a single layer structure or a stacked structure.

The nozzle plate 54 is formed to a size corresponding to the outer shape of the step portion 53c of the support plate 53. That is, the nozzle plate 54 is formed in a rectangular plate shape having a longer side in the X direction. For example, the thickness of the nozzle plate 54 is about 50 μm.

In the nozzle plate 54, nozzle holes 63 which penetrate the plate in the Z direction are formed. Each nozzle hole 63 allows the ink to flow in the Z direction from the upper side to the lower side and jets the ink from a downstream opening. For example, each nozzle hole 63 is formed in a tapered shape whose diameter gradually decreases from the upper side to the lower side. The nozzle holes 63 are formed in the nozzle plate 54 at positions facing the discharge channels 55 in the Z direction separately. That is, the nozzle holes 63 are formed at intervals in the X direction. Accordingly, the discharge channels 55 communicate with the outside through the nozzle holes 63. On the other hand, the non-discharge channels 56 are closed by the nozzle plate 54. Hereinafter, a region where the nozzle holes 63 (nozzle array) arranged in the X direction are formed in the nozzle plate 54 is referred to as “nozzle hole forming region 54b”. As shown in FIG. 3, the nozzle hole forming region 54b is exposed downward through an opening portion 72 of the nozzle cover plate 71.

### Nozzle Cover Plate

The nozzle cover plate 71 is bonded and fixed to the discharge surface 54a of the nozzle plate 54 by thermocompression bonding. The nozzle cover plate 71 is desirably made of a material having higher rigidity than that of the nozzle plate 54. For example, the nozzle cover plate 71 is formed by subjecting a thin plate or the like made of stainless steel to press working or etching working.

The nozzle cover plate 71 has substantially the same outer shape as that of the nozzle plate 54. That is, the nozzle cover plate 71 is formed in a rectangular frame shape having a longer side in the X direction. The nozzle cover plate 71 is formed so as to cover the discharge surface 54a of the nozzle plate 54 avoiding the nozzle hole forming region 54b. As shown in FIG. 4, in the nozzle cover plate 71, the opening portion 72 in a slit-like shape which penetrates the plate in the Z direction and extends along the X direction is formed. The shape of the opening portion 72 is not limited to the slit-like shape, and various shapes such as a circle, an ellipse, and a rectangle can be adopted as long as the respective nozzle holes 63 are configured to be exposed downward.

For example, a water-repellent film may be applied to an outer surface 71a (a surface on the opposite side to the nozzle plate 54) of the nozzle cover plate 71. This can prevent the ink from adhering to the nozzle cover plate 71 and remaining thereon as much as possible. Incidentally, the discharge surface 54a of the nozzle plate 54 and an upper surface (a surface on the nozzle plate 54 side) of the nozzle cover plate 71 to be joined to the discharge surface 54a are each desirably hydrophilic. This can increase the joining force between the nozzle plate 54 and the nozzle cover plate 71.

Meanwhile, a water-repellent film may be applied to the discharge surface 54a of the nozzle plate 54. This can prevent the ink from adhering to the discharge surface 54a of the nozzle plate 54 and remaining thereon as much as possible. Further, a water-repellent film may not be applied to the lower surface of the nozzle cover plate 71.

### Printer Operation Method

Next, a method for recording information on the recording medium P using the printer 1 (see FIG. 1) will be described.

As shown in FIG. 1, when the printer 1 is operated, the grid rollers 11 and 13 of the conveyance mechanisms 2 and 3 rotate, and thus, the recording medium P is conveyed in the X direction between the grid rollers 11 and 13 and the pinch rollers 12 and 14. Further, simultaneously with the conveyance of the recording medium P, the drive motor 28 rotates the pulley 26 to cause the endless belt 27 to travel. Accordingly, the carriage 23 moves back and forth in the Y direction while being guided by the guide rails 21 and 22.

During this operation, in each of the ink jet heads 5, a drive voltage is applied to the drive electrode of the head chip 32. This causes thickness-shear deformation in the drive wall 57 and generates a pressure wave in the ink filled in the discharge channel 55. By this pressure wave, the internal pressure of the discharge channel 55 is increased, so that the ink is discharged through the nozzle hole 63. Then, the ink lands on the recording medium P, whereby various information is recorded on the recording medium P.

### Method for Producing Nozzle Plate

Next, a method for producing the nozzle plate 54 (a method for producing the nozzle plate body 70) of the embodiment will be described.

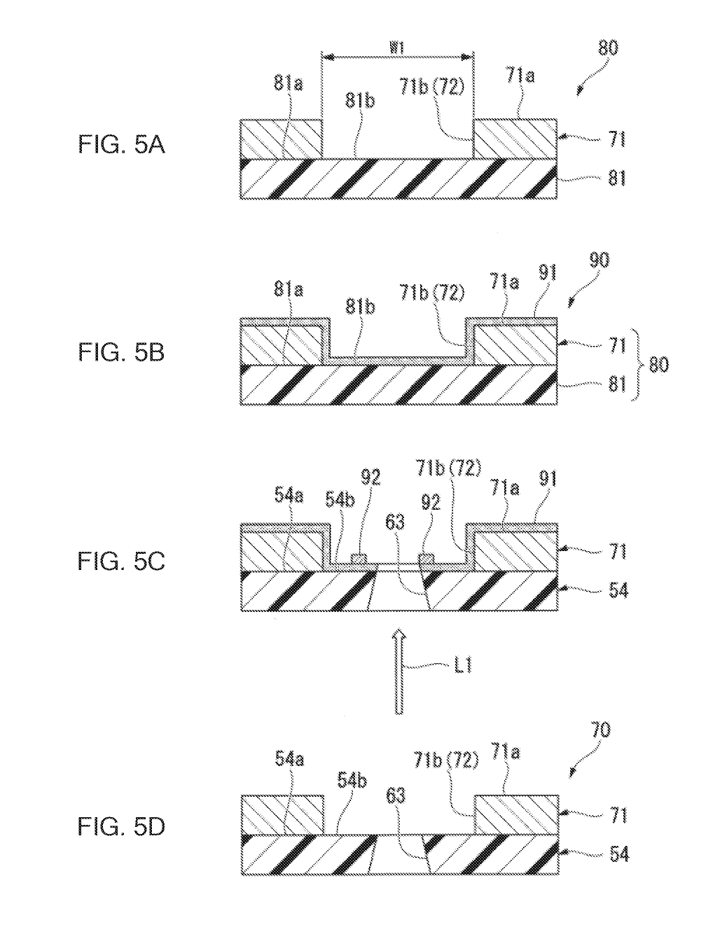

FIGS. 5A to 5D are process diagrams for illustrating the method for producing the nozzle plate 54 of the embodiment. FIGS. 5A to 5D show cross-sectional views, and each illustrate a state where the up and down directions of the process diagram are reversed from the up and down directions of the nozzle plate 54.

The method for producing the nozzle plate 54 of this embodiment includes a substrate preparation step of preparing a coating agent-applied substrate 90 in which a coating agent 91 is applied to a part of a nozzle plate substrate 81 which is a base material of the nozzle plate 54, a nozzle hole formation step of forming the nozzle hole 63 in the coating agent-applied substrate 90, and a coating agent removal step of removing the coating agent 91. The substrate preparation step of this embodiment includes a joined body preparation step of preparing a joined body 80 of the nozzle plate substrate 81 and the nozzle cover plate 71, and a coating agent application step of applying the coating agent 91 to the joined body 80.

FIG. 5A is a process diagram for illustrating the joined body preparation step of the embodiment.

As shown in FIG. 5A, in the joined body preparation step, the joined body 80 of the nozzle plate substrate 81 and the nozzle cover plate 71 having the opening portion 72 for exposing a nozzle hole forming region 81b of the nozzle plate substrate 81 is prepared. Here, the nozzle hole forming region 81b is a region where a nozzle array is formed on one surface 81a of the nozzle plate substrate 81.

As the nozzle plate substrate 81, for example, a polyimide substrate is used. As the nozzle cover plate 71, for example, an SUS substrate is used. The opening portion 72 of the nozzle cover plate 71 is formed by, for example, etching. The opening portion 72 is formed larger than the nozzle hole 63 to be formed in the nozzle hole forming region 81b. The width W1 of the opening portion 72 is set to, for example, 0.15 mm or more and 1 mm or less.

In the joined body preparation step, the nozzle cover plate 71 is joined to the surface 81a of the nozzle plate substrate 81, whereby the joined body 80 is obtained. For example, the nozzle cover plate 71 is disposed on the surface 81a of the nozzle plate substrate 81, and the nozzle plate substrate 81 and the nozzle cover plate 71 are bonded to each other by thermocompression bonding. In this manner, the joined body 80 of the nozzle plate substrate 81 and the nozzle cover plate 71 is prepared.

After the joined body preparation step, the process proceeds to the coating agent application step.

FIG. 5B is a process diagram for illustrating the coating agent application step of the embodiment.

As shown in FIG. 5B, in the coating agent application step, the coating agent 91 is applied to at least the nozzle hole forming region 81b of the joined body 80. As the coating agent 91, a liquid material capable of penetrating into the opening portion 72 is used. As the coating agent 91, for example, polyvinyl alcohol (PVA) or a water-soluble organic compound, which has excellent hydrophilicity and is easily removed by washing with water, is used.

Specifically, in the coating agent application step, the coating agent 91 is applied to the nozzle hole forming region 81b, an inner surface 71b surrounding the opening portion 72 of the nozzle cover plate 71, and the outer surface 71a on the opposite side to the joining surface to the nozzle plate substrate 81 of the nozzle cover plate 71. The coating agent 91 is applied by, for example, a bar coater. The coating agent 91 may be applied by spraying.

In the coating agent application step, the coating agent 91 is continuously applied to the nozzle hole forming region 81b, the inner surface 71b surrounding the opening portion 72 of the nozzle cover plate 71, and the outer surface 71a of the nozzle cover plate 71.

After the coating agent application step, the process proceeds to the nozzle hole formation step.

FIG. 5C is a process diagram for illustrating the nozzle hole formation step of the embodiment.

As shown in FIG. 5C, in the nozzle hole formation step, the nozzle hole 63 is formed in the region, to which the coating agent 91 is applied, of the coating agent-applied substrate 90. In the nozzle hole formation step, the nozzle hole 63 is formed using a laser beam. In the nozzle hole formation step, the nozzle hole forming region 81b is irradiated with a laser beam at a central position in the width direction of the opening portion 72 therein.

In the nozzle hole formation step, the nozzle hole forming region 81b is irradiated with the laser beam from the other surface side of the nozzle plate substrate 81 (the direction indicated by the arrow L1). The irradiation direction of the laser beam may be a direction in which the nozzle hole forming region 81b is irradiated with the laser beam through the opening portion 72 from the surface 81a side of the nozzle plate substrate 81 (the direction opposite to the direction indicated by the arrow L1).

When the nozzle plate substrate 81 is heated by the laser beam, the nozzle plate substrate 81 may be thermally deformed. However, in tis embodiment, the nozzle cover plate 71 is bonded to the nozzle plate substrate 81, and therefore, thermal deformation of the nozzle plate substrate 81 can be suppressed. Accordingly, the nozzle hole 63 can be accurately formed.

After the nozzle hole formation step, the process proceeds to the coating agent removal step. A reference numeral 92 in FIG. 5C denotes a debris occurring during the formation of the nozzle hole 63. In this embodiment, the nozzle hole 63 is formed after the coating agent application step, and therefore, the debris 92 is disposed on the coating agent 91. The debris 92 occurs regardless of the irradiation direction of the laser beam.

FIG. 5D is a process diagram for illustrating the coating agent removal step of the embodiment.

As shown in FIG. 5D, in the coating agent removal step, all the coating agent 91 applied to the nozzle hole forming region 54b, the inner surface 71b surrounding the opening portion 72 in the nozzle cover plate 71, and the outer surface 71a of the nozzle cover plate 71 is removed. For example, in the coating agent removal step, the coating agent 91 is removed by washing with water. In the coating agent removal step, the coating agent 91 is removed, and also the debris 92 is removed simultaneously.

After the coating agent removal step, a water-repellent film (not shown) may be applied to the outer surface 71a of the nozzle cover plate 71.

According to the above steps, the production of the nozzle plate 54 (nozzle plate body 70) is completed.

As described above, the method for producing the nozzle plate 54 according to this embodiment includes the substrate preparation step of preparing the coating agent-applied substrate 90 in which the coating agent 91 is applied to a part of the nozzle plate substrate 81, the nozzle hole formation step of forming the nozzle hole 63 in a region, to which the coating agent 91 is applied, of the coating agent-applied substrate 90 after the substrate preparation step, and the coating agent removal step of removing the coating agent 91 after the nozzle hole formation step.

According to this embodiment, even in the case where the debris 92 occurs during the formation of the nozzle hole 63, the debris 92 can be collectively removed together with the coating agent 91 in the coating agent removal step, and therefore, the removal of the debris 92 can be easily performed. Accordingly, the discharge accuracy of the nozzle can be improved. Further, when a debris remained around the nozzle hole, the discharged ink deflected, and therefore, the discharge accuracy of the ink jet head was deteriorated in some cases. However, according to this embodiment, the discharge accuracy of the ink jet head 5 can be improved.

Further, in this embodiment, the substrate preparation step includes the joined body preparation step of preparing the joined body 80 of the nozzle plate substrate 81 and the nozzle cover plate 71 having the opening portion 72 for exposing the nozzle hole forming region 81b of the nozzle plate substrate 81, and the coating agent application step of applying the coating agent 91 to at least the nozzle hole forming region 81b of the joined body 80 after the joined body preparation step.

In the meantime, as a method for removing the debris 92, there is a method using an adhesive tape without using a coating agent. However, in the case where the debris 92 occurs in the nozzle hole forming region 81b, the opening portion 72 of the nozzle cover plate 71 is generally smaller than a fingertip, and therefore, the adhesive tape does not sufficiently penetrate into the nozzle hole forming region 81b, and there is a possibility that the debris 92 cannot be sufficiently removed. On the other hand, according to this method, even in the case where the debris 92 occurs in the nozzle hole forming region 81b, the debris 92 can be collectively removed together with the coating agent 91 in the coating agent removal step, and therefore, this method is preferred.

Further, in this embodiment, in the coating agent application step, the coating agent 91 is applied to the nozzle hole forming region 81b and the inner surface 71b surrounding the opening portion 72 of the nozzle cover plate 71.

According to this embodiment, even in the case where the debris 92 occurs on the inner surface 71b surrounding the opening portion 72 of the nozzle cover plate 71 in addition to the nozzle hole forming region 81b, the debris 92 in each place can be collectively removed together with the coating agent 91 in the coating agent removal step. Therefore, the appearance of the nozzle plate 54 (nozzle plate body 70) can be improved.

Further, in this embodiment, in the coating agent application step, the coating agent 91 is applied to the nozzle hole forming region 81b and the outer surface 71a on the opposite side to the joining surface to the nozzle plate substrate 81 of the nozzle cover plate 71.

According to this embodiment, even in the case where the debris 92 occurs on the outer surface 71a of the nozzle cover plate 71 in addition to the nozzle hole forming region 81b, the debris 92 in each place can be collectively removed together with the coating agent 91 in the coating agent removal step. Therefore, the appearance of the nozzle plate 54 (nozzle plate body 70) can be improved.

Further, in this embodiment, in the nozzle hole formation step, the nozzle hole 63 is formed using a laser beam.

According to this embodiment, the debris 92 is more likely to occur as compared with the case where the nozzle hole 63 is formed using a punch, and therefore, the practical benefit for removing the debris 92 is high.

Further, in this embodiment, in the coating agent removal step, the coating agent 91 is removed by washing with water.

According to this embodiment, the removal of the debris 92 can be performed more easily at lower cost as compared with the case where the coating agent 91 is removed using a chemical solution.

### Variations

The technical scope of the invention is not limited to the above-mentioned embodiments, and various modifications can be added without departing from the gist of the invention.

For example, the invention may be applied to a method for producing the ink jet head 5 including a step of producing the nozzle plate 54 using the method for producing the nozzle plate 54 described above.

For example, in the above-mentioned embodiment, an example in which the substrate preparation step includes the joined body preparation step of preparing the joined body 80 of the nozzle plate substrate 81 and the nozzle cover plate 71 having the opening portion 72 for exposing the nozzle hole forming region 81b of the nozzle plate substrate 81 has been described, however, the invention is not limited thereto. For example, in the substrate preparation step, only the nozzle plate substrate 81 may be prepared without preparing the nozzle cover plate 71. That is, in the substrate preparation step, the coating agent-applied substrate 90 in which the coating agent 91 is applied to at least a part of the nozzle plate substrate 81 may be prepared. For example, after the nozzle hole 63 is formed in the coating agent-applied substrate 90 to which the coating agent 91 has already been applied, the coating agent 91 may be removed.

Further, in the above-mentioned embodiment, an example in which in the coating agent application step, the coating agent 91 is applied to the nozzle plate substrate 81 on the nozzle cover plate 71 side has been described, however, the invention is not limited thereto. For example, in the coating agent application step, the coating agent 91 may be applied to the nozzle plate substrate 81 on the side opposite to the nozzle cover plate 71. That is, in the coating agent application step, the coating agent 91 may be applied to both surfaces of the nozzle plate substrate 81.

Further, in the above-mentioned embodiment, an example in which in the coating agent application step, the coating agent 91 is applied to the nozzle hole forming region 81b, the inner surface 71b surrounding the opening portion 72 of the nozzle cover plate 71, and the outer surface 71a of the nozzle cover plate 71 has been described, however, the invention is not limited thereto. For example, in the coating agent application step, the coating agent 91 may not be applied to at least one of the inner surface 71b surrounding the opening portion 72 of the nozzle cover plate 71 and the outer surface 71a of the nozzle cover plate 71. That is, in the coating agent application step, the coating agent 91 may only be applied to at least the nozzle hole forming region 81b.

Further, in the above-mentioned embodiment, an example in which in the coating agent application step, as the coating agent 91, a liquid material capable of penetrating into the opening portion 72 is used has been described, however, the invention is not limited thereto. For example, a solid such as a sealing material may be melted by heat and filled in the opening portion 72 and then solidified. For example, the sealing material in the opening portion 72 may be removed by melting after the nozzle hole formation step.

Further, in the above-mentioned embodiment, an example in which in the nozzle hole formation step, the nozzle hole 63 is formed using a laser beam has been described, however, the invention is not limited thereto. For example, in the nozzle hole formation step, the nozzle hole 63 may be formed using a punch.

Further, in the above-mentioned embodiment, an example in which in the coating agent removal step, the coating agent 91 is removed by washing with water has been described, however, the invention is not limited thereto. For example, in the coating agent removal step, the coating agent 91 may be removed using a chemical solution. For example, in the case where acetone or xylene is used as the chemical solution, as the coating agent 91, a resist which is easily removed with acetone or xylene is used.

Further, in the above-mentioned embodiment, an ink jet head of a so-called wall bend type among the ink jet heads of a piezo system has been described, however, the invention is not limited thereto. For example, the invention may be applied to an ink jet head of a so-called roof shoot type (the direction of a pressure to be applied to an ink and the discharge direction of an ink droplet are the same), or an ink jet head of another piezo system among the ink jet heads of a piezo system.

Further, the system is not limited to the piezo system, and the invention may be applied also to an ink jet head of a thermal system, or the like.

Further, in the above-mentioned embodiment, an ink jet head of an edge shoot type has been described, however, the invention is not limited thereto. For example, the invention may be applied to an ink jet head of a so-called side shoot type in which an ink is discharged from a central portion in the extending direction of a discharge channel.

In addition to the above, the component in the above-mentioned embodiment can be appropriately replaced with a known component without departing from the gist of the invention.

What is claimed is:

1. A method for producing a nozzle plate, comprising:
a substrate preparation step of preparing a coating agent-applied substrate in which a coating agent is applied to at least a part of a nozzle plate substrate;
a nozzle hole formation step of forming a nozzle hole in a region, to which the coating agent is applied, of the coating agent-coated substrate after the substrate preparation step; and
a coating agent removal step of removing the coating agent after the nozzle hole formation step.

2. The method for producing a nozzle plate according to claim 1, wherein
the substrate preparation step includes
a joined body preparation step of preparing a joined body of the nozzle plate substrate and a cover plate having an opening portion for exposing a nozzle hole forming region of the nozzle plate substrate, and
a coating agent application step of applying the coating agent to at least the nozzle hole forming region of the joined body after the joined body preparation step.

3. The method for producing a nozzle plate according to claim 2, wherein in the coating agent application step, the coating agent is applied to the nozzle hole forming region and an inner surface surrounding the opening portion of the cover plate.

4. The method for producing a nozzle plate according to claim 2, wherein in the coating agent application step, the coating agent is applied to the nozzle hole forming region and an outer surface on the opposite side to a joining surface to the nozzle plate substrate of the cover plate.

5. The method for producing a nozzle plate according to claim 3, wherein in the coating agent application step, the coating agent is applied to the nozzle hole forming region and an outer surface on the opposite side to a joining surface to the nozzle plate substrate of the cover plate.

6. The method for producing a nozzle plate according to claim 1, wherein in the nozzle hole formation step, the nozzle hole is formed using a laser beam.

7. The method for producing a nozzle plate according to claim 1, wherein in the coating agent removal step, the coating agent is removed by washing with water.

8. A method for producing a liquid jet head, comprising producing a nozzle plate using the method for producing a nozzle plate according to claim 1.
